(19) United States
(12) Patent Application Publication
(10) Pub. No.: US 2016/0244358 A1
(43) Pub. Date: Aug. 25, 2016

(54) Quartz Glass Part and Fabrication Method for Quartz Glass Part

(71) Applicants: TECHNO QUARTZ INC., Tokyo (JP); TOCALO CO., LTD, Hyogo (JP)

(72) Inventors: Hiromichi Isogai, Yamagata-shi, Yamagata (JP); Masahide Kato, Yamagata-shi, Yamagata (JP); Yasuhiro Umetsu, Yamagata-shi, Yamagata (JP); Ryo Yamazaki, Kobe-shi, Hyogo (JP); Yoichiro Habu, Kobe-shi, Hyogo (JP)

(21) Appl. No.: 15/025,828

(22) PCT Filed: Sep. 26, 2014
(86) PCT No.: PCT/JP2014/075596

§ 371 Date: Mar. 29, 2016

(30) Foreign Application Priority Data
Sep. 30, 2013 (JP) 2013-205494

(51) Int. Cl. C03C 17/22; C03C 15/00

(52) U.S. Cl. CPC C03C 17/22; C03C 15/00; C03C 2218/13; C03C 2218/33

(57) ABSTRACT

A quartz glass part silicon powder is plasma-sprayed onto a surface of a quartz glass substrate and thereby a coating film is formed, the quartz glass substrate is composed of opaque quartz glass a fraction of grains having a diameter of 100 μm or larger in the silicon powder is 3% or smaller.

### CROSS-REFERENCE TO RELATED APPLICATIONS

This application is the national phase under 35 U.S.C. §371 of PCT International Application No. PCT/JP2014/075596 which has an International filing date of Sep. 26, 2014 and designated the United States of America.

### FIELD

The present invention relates to a quartz glass part and a fabrication method for the quartz glass part.

### BACKGROUND

In general, a high-temperature heat treatment apparatus is employed for irradiating a semiconductor wafer with infrared radiation in an inert atmosphere or an oxidizing atmosphere for the purpose of crystal integrity improvement or surface modification. The high-temperature heat treatment apparatus performs the processing in a high-temperature environment of 400 to 1400 degree C.

Thus, as structural parts in the device inside and periphery, quartz glass parts are widely employed that have excellent heat resisting properties and that are allowed to be easily machined.

In a common high-temperature heat treatment apparatus, a transparent quartz glass part is arranged in a portion transmitting infrared radiation.

Further, an opaque quartz glass part containing internal microbubbles is arranged in a portion shielding infrared radiation.

However, in the high-temperature heat treatment apparatus of the conventional art, a problem arises that infrared radiation having passed through the transparent quartz glass part heats an O-ring provided in a sealing portion of the high-temperature heat treatment apparatus and thereby the heated O-ring suffers tensile strength decrease or melting so as to be deteriorated or cut so that a fault is caused.

In view of such a problem, for example, Japanese Patent Application Laid-Open Publication No. H03-291917 discloses a quartz glass part in which the surface of the quartz glass part is coated with SiC so that the heat shielding property is improved.

Further, Japanese Patent Application Laid-Open Publication No. 2010-513198 discloses a fabrication method for a quartz glass part having an infrared reflecting function, which is achieved by covering the surface of a quartz glass substrate with a porous quartz-glass thermal-sprayed film. (For other examples, see Japanese Patent Application Laid-Open Publication No. 2009-54984, Japanese Patent Application Laid-Open Publication No. 2007-250569, and Japanese Patent Application Laid-Open Publication No. 2004-143583.)

### SUMMARY

Meanwhile, in high-temperature heat treatment apparatuses of recent years, from a requirement of precision control of a heat treatment process, a peripheral mechanism part such as various kinds of precision parts, precision drive mechanisms, measurement instruments, and monitoring mechanisms is arranged in the periphery of a high-temperature processing part.

Further, in high-temperature heat treatment apparatuses of recent years, with increasing size of the semiconductor wafer, the system is transiting from a batch process to a single-wafer process.

Thus, the size of the high-temperature processing part is increasing and hence, in some cases, a space between the high-temperature processing part and the peripheral mechanism part becomes narrow.

In such a high-temperature heat treatment apparatus, a thickness-reduced opaque quartz glass part is to be arranged in the above-described space for the purpose of shielding infrared radiation entering from the high-temperature processing part to the peripheral mechanism part.

However, the thickness-reduced opaque quartz glass part has caused a problem of difficulty in sufficiently shielding the infrared radiation entering the peripheral mechanism part.

The present invention has been devised in view of such situations and an object thereof is to provide: a quartz glass part in which thickness reduction is achieved and a light shielding property and a heat resisting property are improved; and a fabrication method for the quartz glass part.

According to the present invention, A quartz glass part constructed such that silicon powder is plasma-sprayed onto a surface of a quartz glass substrate and thereby a coating film is formed the quartz glass substrate is composed of opaque quartz glass and a fraction of grains having a diameter of 100 μm or larger in the silicon powder is 3% or smaller.

According to the present invention, the quartz glass part includes the opaque quartz glass substrate and the fraction of grains having a diameter of 100 μm or larger in the silicon powder is 3% or smaller. By virtue of this, in the quartz glass part, thickness reduction is allowed to be achieved and the light shielding property and the heat resisting property are allowed to be improved.

### BRIEF DESCRIPTION OF DRAWINGS

FIGS. 1A to 1D are schematic diagrams schematically illustrating a fabrication method for a quartz glass part.

FIG. 2 is an explanation diagram illustrating a formation process for a coating film performed by a plasma torch part of a plasma spraying apparatus.

FIG. 3 is a graph illustrating transmissivities of opaque quartz glass I.

FIG. 4 is a graph illustrating transmissivities of transparent quartz glass I and transparent quartz glass II.

FIG. 5 is a graph illustrating transmissivities of quartz glass parts prior to heating.

FIG. 6 is a graph illustrating transmissivities of quartz glass parts posterior to heating.

FIGS. 7A to 7F are schematic diagrams schematically illustrating a fabrication method for a quartz glass part according to Embodiment 3.

FIGS. 8A to 8C are schematic diagrams schematically illustrating a re-formation method for a coating film of a quartz glass part.

### DETAILED DESCRIPTION

The present invention is described below in detail with reference to the drawings illustrating the embodiments.

### Embodiment 1

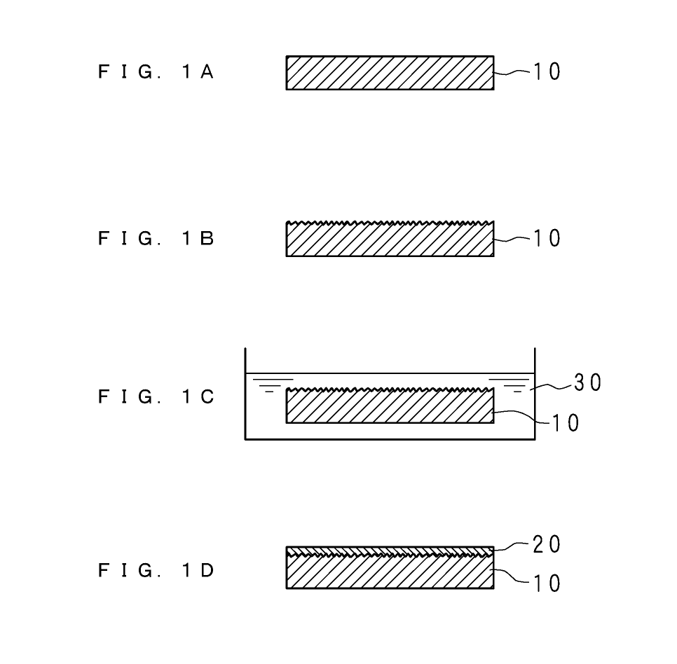

FIGS. 1A to 1D are schematic diagrams schematically illustrating a fabrication method for a quartz glass part.

The fabrication method for a quartz glass part according to the present embodiment is described below.

First, a quartz glass substrate 10 is prepared. The quartz glass substrate 10 is composed of opaque quartz glass, in which microbubbles are contained in the inside so that opacification is achieved.

Here, in the quartz glass substrate 10 in the present embodiment, a flat-plate shape is employed as an example.

However, employable shapes are not limited to this.

For example, the employed quartz glass substrate 10 may have a tube shape, a column shape, and a prism shape or, alternatively, may be a quartz glass substrate having been cut or machined into an arbitrary shape.

FIG. 1A illustrates a sectional view of the quartz glass substrate 10 whose shape machining has been achieved by grinding.

Then, one surface (a surface on the thermal-sprayed surface side) of the quartz glass substrate 10 is ground by using a grinding machine provided with a metal-bonded grinding wheel.

For example, the metal-bonded grinding wheel is a diamond wheel. Alternatively, the one surface of the quartz glass substrate 10 may be roughened by sand blast processing. The sandblast indicates a processing method of spraying compressed air discharged from a compressor, together with abrasive grains onto a to-be-ground material and thereby roughening the surface of the to-be-ground material. FIG. 1B illustrates a sectional view of the quartz glass substrate 10 having been ground. In general, as a method of improving adhesion between the thermal-sprayed film and the substrate, the substrate surface is roughened before the thermal spraying.

Further, the quartz glass substrate 10 having been ground is immersed in an HF solution (a hydrofluoric-acid-based chemical liquid) 30 so that etching is performed. For example, when etching of a depth of 20 μm is to be performed on the quartz glass substrate 10, the quartz glass substrate 10 having been ground is immersed in the HF solution 30 having a concentration of 15% and a solution temperature of 20 degree C., for 2 hours. FIG. 1C illustrates a sectional view of the quartz glass substrate 10 in the etching process. Here, although the quartz glass substrate 10 in the present embodiment is immersed in the HF solution 30, employable methods are not limited to this. For example, the quartz glass substrate 10 may be immersed in a chemical liquid such as a buffered hydrofluoric acid (BHF) solution or an ammonium hydrogendifluoride (NH₄F.HF) solution.

Further, from a plasma spraying apparatus described later, silicon powder is thermal-sprayed onto the quartz glass substrate 10 having been etched, so that a coating film 20 is formed in a portion where light shielding or heat shielding is required. FIG. 1D illustrates a sectional view of the quartz glass substrate 10 on which the coating film 20 has been formed.

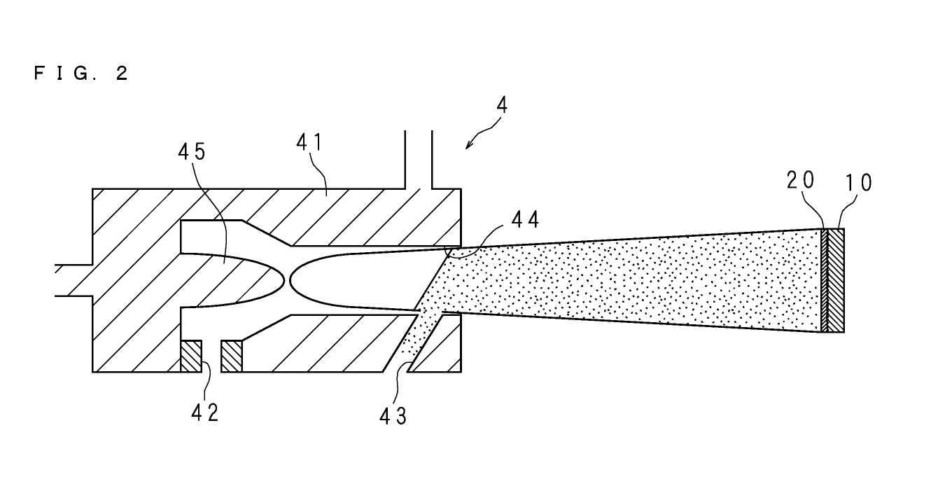

FIG. 2 is an explanation diagram illustrating a formation process for the coating film 20 performed by a plasma torch part 4 of the plasma spraying apparatus. Here, in FIG. 2, the left side in the page corresponds to the bottom face side of the plasma torch part 4, the right side in the page corresponds to the upper face side of the plasma torch part 4, and the directions perpendicular to the page correspond to the right and left directions of the plasma torch part 4.

The plasma torch part 4 illustrated in FIG. 2 has a closed-end tube shape and is connected to a power supply (not illustrated). The plasma torch part 4 includes: a cathode 45 provided in the bottom part; an anode 41 provided in the upper part of the tube shape peripheral surface; a supply port 42 formed on the right side of the cathode 45 and supplying rare gas; and a supply port 43 formed on the right side of the anode 41 and supplying silicon powder.

A formation process of forming the coating film 20 onto the quartz glass substrate 10 is described below with reference to FIG. 2. First, in the quartz glass substrate 10 having been etched, one surface having been ground is arranged opposite to the cathode 45 of the plasma torch part 4. In the plasma spraying apparatus, a voltage is applied between the cathode 45 and the anode 41 by a power supply so that arc discharge is generated. In the plasma torch part 4, rare gas (e.g., argon) is supplied through the supply port 42 and then the supplied rare gas is ionized by the arc discharge so that a plasma jet is generated. In the plasma torch part 4, silicon powder is supplied through the supply port 43. Then, the supplied silicon powder is heated in the inside of the plasma jet and then sprayed in a molten state through an opening part 44 opened in the upper face. The plasma torch part 4 thermal-sprays the discharged silicon powder onto a portion requiring light shielding or heat shielding in the quartz glass substrate 10 arranged at a countered position to the opening part 44. The molten silicon powder collides with the substrate surface so as to be flattened and, at the same time, immediately solidified so that a deposited layer is formed. As a result of the above-described formation process, the coating film 20 is formed in a portion requiring light shielding or heat shielding in the quartz glass substrate 10.

Here, usually, a process of moving the plasma torch part 4 and the quartz glass substrate 10 is performed depending on the shape of the quartz glass substrate and the region where the thermal-sprayed film is to be formed.

Further, in the quartz glass substrate, the thermal spraying is performed in a state that a portion where the thermal-sprayed film is not to be formed is masked.

Fabrication examples of the quartz glass part are listed in the following Tables 1 and 2.

TABLE 1

| | | COATING FILM | | QUARTZ GLASS SUBSTRATE | | |
|---|---|---|---|---|---|---|
| | | | AVERAGE | SURFACE | | |
| FABRICATION | | | FILM | ROUGHNESS | PROCESSING | ETCHING |
| EXAMPLE | TYPE | POROSITY | THICKNESS | Ra | CONDITION | AMOUNT |
| FABRICATION | OPAQUE QUARTZ | 1~4 | 20 ± 5 | 2~4 | GRINDING | 10 ± 2 |
| EXAMPLE 1 | GLASS I | | | | | |
| FABRICATION | OPAQUE QUARTZ | 1~4 | 30 ± 5 | 2~4 | GRINDING | 10 ± 2 |
| EXAMPLE 2 | GLASS I | | | | | |
| FABRICATION | OPAQUE QUARTZ | 1~4 | 40 ± 5 | 2~4 | GRINDING | 10 ± 2 |
| EXAMPLE 3 | GLASS I | | | | | |
| FABRICATION | OPAQUE QUARTZ | 1~4 | 50 ± 5 | 2~4 | GRINDING | 10 ± 2 |
| EXAMPLE 4 | GLASS I | | | | | |
| FABRICATION | OPAQUE QUARTZ | 1~4 | 60 ± 5 | 2~4 | GRINDING | 10 ± 2 |
| EXAMPLE 5 | GLASS I | | | | | |
| FABRICATION | OPAQUE QUARTZ | 1~4 | 70 ± 5 | 2~4 | GRINDING | 10 ± 2 |
| EXAMPLE 6 | GLASS I | | | | | |
| FABRICATION | OPAQUE QUARTZ | 1~4 | 80 ± 5 | 2~4 | GRINDING | 10 ± 2 |
| EXAMPLE 7 | GLASS I | | | | | |
| FABRICATION | OPAQUE QUARTZ | 1~4 | 90 ± 5 | 2~4 | GRINDING | 10 ± 2 |
| EXAMPLE 8 | GLASS I | | | | | |
| FABRICATION | OPAQUE QUARTZ | 1~4 | 50 ± 5 | 2~4 | GRINDING | 1 ± 1 |
| EXAMPLE 9 | GLASS I | | | | | |
| FABRICATION | OPAQUE QUARTZ | 1~4 | 50 ± 5 | 2~4 | GRINDING | 5 ± 1 |
| EXAMPLE 10 | GLASS I | | | | | |
| FABRICATION | OPAQUE QUARTZ | 1~4 | 50 ± 5 | 2~4 | GRINDING | 10 ± 2 |
| EXAMPLE 11 | GLASS I | | | | | |
| FABRICATION | OPAQUE QUARTZ | 1~4 | 50 ± 5 | 2~4 | GRINDING | 10 ± 2 |
| EXAMPLE 12 | GLASS I | | | | | |
| FABRICATION | OPAQUE QUARTZ | 1~4 | 20 ± 5 | 2~4 | GRINDING | 10 ± 2 |
| EXAMPLE 13 | GLASS II | | | | | |
| FABRICATION | OPAQUE QUARTZ | 1~4 | 30 ± 5 | 2~4 | GRINDING | 10 ± 2 |
| EXAMPLE 14 | GLASS II | | | | | |
| FABRICATION | OPAQUE QUARTZ | 1~4 | 40 ± 5 | 2~4 | GRINDING | 10 ± 2 |
| EXAMPLE 15 | GLASS II | | | | | |
| FABRICATION | OPAQUE QUARTZ | 1~4 | 50 ± 5 | 2~4 | GRINDING | 10 ± 2 |
| EXAMPLE 16 | GLASS II | | | | | |
| FABRICATION | OPAQUE QUARTZ | 1~4 | 60 ± 5 | 2~4 | GRINDING | 10 ± 2 |
| EXAMPLE 17 | GLASS II | | | | | |
| FABRICATION | OPAQUE QUARTZ | 1~4 | 70 ± 5 | 2~4 | GRINDING | 10 ± 2 |
| EXAMPLE 18 | GLASS II | | | | | |
| FABRICATION | OPAQUE QUARTZ | 1~4 | 80 ± 5 | 2~4 | GRINDING | 10 ± 2 |
| EXAMPLE 19 | GLASS II | | | | | |
| FABRICATION | OPAQUE QUARTZ | 1~4 | 90 ± 5 | 2~4 | GRINDING | 10 ± 2 |
| EXAMPLE 20 | GLASS II | | | | | |

| | SILICON POWDER | | | |
|---|---|---|---|---|
| | | A FRACTION | EVALUATION OF | |
| | | OF GRAIN | PERFORMANCE | |
| | D50% | DIAMETER | LIGHT | HEAT |
| FABRICATION | GRAIN | OF 100 μm | SHIELDING | RESISTING |
| EXAMPLE | DIAMETER | OR LARGER | PERFORMANCE | PERFORMANCE |
| FABRICATION | 25~35 | 0 | X | ⊚ |
| EXAMPLE 1 | | | | |
| FABRICATION | 25~35 | 0 | ◯ | ⊚ |
| EXAMPLE 2 | | | | |
| FABRICATION | 25~35 | 0 | ⊚ | ⊚ |
| EXAMPLE 3 | | | | |
| FABRICATION | 25~35 | 0 | ⊚ | ⊚ |
| EXAMPLE 4 | | | | |
| FABRICATION | 25~35 | 0 | ⊚ | ⊚ |
| EXAMPLE 5 | | | | |
| FABRICATION | 25~35 | 0 | ⊚ | ◯ |
| EXAMPLE 6 | | | | |
| FABRICATION | 25~35 | 0 | ⊚ | ◯ |
| EXAMPLE 7 | | | | |
| FABRICATION | 25~35 | 0 | ⊚ | X |
| EXAMPLE 8 | | | | |
| FABRICATION | 25~35 | 0 | ⊚ | X |
| EXAMPLE 9 | | | | |
| FABRICATION | 25~35 | 0 | ⊚ | ◯ |
| EXAMPLE 10 | | | | |
| FABRICATION | 50~60 | 3 | ◯ | ◯ |
| EXAMPLE 11 | | | | |
| FABRICATION | 70~80 | 10 | X | ◯ |
| EXAMPLE 12 | | | | |
| FABRICATION | 25~35 | 0 | ◯ | ⊚ |
| EXAMPLE 13 | | | | |
| FABRICATION | 25~35 | 0 | ◯ | ⊚ |
| EXAMPLE 14 | | | | |
| FABRICATION | 25~35 | 0 | ⊚ | ⊚ |
| EXAMPLE 15 | | | | |
| FABRICATION | 25~35 | 0 | ⊚ | ◯ |
| EXAMPLE 16 | | | | |
| FABRICATION | 25~35 | 0 | ⊚ | ◯ |
| EXAMPLE 17 | | | | |
| FABRICATION | 25~35 | 0 | ⊚ | ◯ |
| EXAMPLE 18 | | | | |
| FABRICATION | 25~35 | 0 | ⊚ | X |
| EXAMPLE 19 | | | | |
| FABRICATION | 25~35 | 0 | ⊚ | X |
| EXAMPLE 20 | | | | |

TABLE 2

| | | COATING FILM | | QUARTZ GLASS SUBSTRATE | | |
|---|---|---|---|---|---|---|
| | | | AVERAGE | SURFACE | | |
| FABRICATION | | | FILM | ROUGHNESS | PROCESSING | ETCHING |
| EXAMPLE | TYPE | POROSITY | THICKNESS | Ra | CONDITION | AMOUNT |
| FABRICATION | OPAQUE QUARTZ | 1~4 | 20 ± 5 | 4~7 | SAND BLAST | 10 ± 2 |
| EXAMPLE 21 | GLASS I | | | | | |
| FABRICATION | OPAQUE QUARTZ | 1~4 | 30 ± 5 | 4~7 | SAND BLAST | 10 ± 2 |
| EXAMPLE 22 | GLASS I | | | | | |
| FABRICATION | OPAQUE QUARTZ | 1~4 | 40 ± 5 | 4~7 | SAND BLAST | 10 ± 2 |
| EXAMPLE 23 | GLASS I | | | | | |
| FABRICATION | OPAQUE QUARTZ | 1~4 | 50 ± 5 | 4~7 | SAND BLAST | 10 ± 2 |
| EXAMPLE 24 | GLASS I | | | | | |
| FABRICATION | OPAQUE QUARTZ | 1~4 | 60 ± 5 | 4~7 | SAND BLAST | 10 ± 2 |
| EXAMPLE 25 | GLASS I | | | | | |
| FABRICATION | OPAQUE QUARTZ | 1~4 | 70 ± 5 | 4~7 | SAND BLAST | 10 ± 2 |
| EXAMPLE 26 | GLASS I | | | | | |
| FABRICATION | OPAQUE QUARTZ | 1~4 | 80 ± 5 | 4~7 | SAND BLAST | 10 ± 2 |
| EXAMPLE 27 | GLASS I | | | | | |
| FABRICATION | OPAQUE QUARTZ | 1~4 | 90 ± 5 | 4~7 | SAND BLAST | 10 ± 2 |
| EXAMPLE 28 | GLASS I | | | | | |
| FABRICATION | OPAQUE QUARTZ | 1~4 | 20 ± 5 | 3~6 | ROUGHENED | 10 ± 2 |
| EXAMPLE 29 | GLASS I | | | | GRINDING | |
| FABRICATION | OPAQUE QUARTZ | 1~4 | 30 ± 5 | 3~6 | ROUGHENED | 10 ± 2 |
| EXAMPLE 30 | GLASS I | | | | GRINDING | |
| FABRICATION | OPAQUE QUARTZ | 1~4 | 40 ± 5 | 3~6 | ROUGHENED | 10 ± 2 |
| EXAMPLE 31 | GLASS I | | | | GRINDING | |
| FABRICATION | OPAQUE QUARTZ | 1~4 | 50 ± 5 | 3~6 | ROUGHENED | 10 ± 2 |
| EXAMPLE 32 | GLASS I | | | | GRINDING | |
| FABRICATION | OPAQUE QUARTZ | 1~4 | 60 ± 5 | 3~6 | ROUGHENED | 10 ± 2 |
| EXAMPLE 33 | GLASS I | | | | GRINDING | |
| FABRICATION | OPAQUE QUARTZ | 1~4 | 70 ± 5 | 3~6 | ROUGHENED | 10 ± 2 |
| EXAMPLE 34 | GLASS I | | | | GRINDING | |
| FABRICATION | OPAQUE QUARTZ | 1~4 | 80 ± 5 | 3~6 | ROUGHENED | 10 ± 2 |
| EXAMPLE 35 | GLASS I | | | | GRINDING | |
| FABRICATION | OPAQUE QUARTZ | 1~4 | 90 ± 5 | 3~6 | ROUGHENED | 10 ± 2 |
| EXAMPLE 36 | GLASS I | | | | GRINDING | |

| | SILICON POWDER | | | |
|---|---|---|---|---|
| | | A FRACTION | EVALUATION OF | |
| | | OF GRAIN | PERFORMANCE | |
| | D50% | DIAMETER | LIGHT | HEAT |
| FABRICATION | GRAIN | OF 100 μm | SHIELDING | RESISTING |
| EXAMPLE | DIAMETER | OR LARGER | PERFORMANCE | PERFORMANCE |
| FABRICATION | 25~35 | 0 | X | ⊚ |
| EXAMPLE 21 | | | | |
| FABRICATION | 25~35 | 0 | ◯ | ◯ |
| EXAMPLE 22 | | | | |
| FABRICATION | 25~35 | 0 | ⊚ | ◯ |
| EXAMPLE 23 | | | | |
| FABRICATION | 25~35 | 0 | ⊚ | ◯ |
| EXAMPLE 24 | | | | |
| FABRICATION | 25~35 | 0 | ⊚ | ◯ |
| EXAMPLE 25 | | | | |
| FABRICATION | 25~35 | 0 | ⊚ | X |
| EXAMPLE 26 | | | | |
| FABRICATION | 25~35 | 0 | ⊚ | X |
| EXAMPLE 27 | | | | |
| FABRICATION | 25~35 | 0 | ⊚ | X |
| EXAMPLE 28 | | | | |
| FABRICATION | 25~35 | 0 | X | ⊚ |
| EXAMPLE 29 | | | | |
| FABRICATION | 25~35 | 0 | ◯ | ⊚ |
| EXAMPLE 30 | | | | |
| FABRICATION | 25~35 | 0 | ⊚ | ◯ |
| EXAMPLE 31 | | | | |
| FABRICATION | 25~35 | 0 | ⊚ | ◯ |
| EXAMPLE 32 | | | | |
| FABRICATION | 25~35 | 0 | ⊚ | ◯ |
| EXAMPLE 33 | | | | |
| FABRICATION | 25~35 | 0 | ⊚ | ◯ |
| EXAMPLE 34 | | | | |
| FABRICATION | 25~35 | 0 | ⊚ | X |
| EXAMPLE 35 | | | | |
| FABRICATION | 25~35 | 0 | ⊚ | X |
| EXAMPLE 36 | | | | |

Quartz glass parts are fabricated in accordance with the fabrication examples of Tables 1 and 2. Each column of Tables 1 and 2 is described below. The type column indicates the type of the quartz glass substrate 10. For example, the type of the quartz glass substrate 10 is opaque quartz glass I or opaque quartz glass II. In the opaque quartz glass I, the average cross-sectional area of microbubbles is 225 to 275 μm×225 to 275 μm and the bubble number density in the quartz glass substrate 10 is 1.20×10³ bubbles/cm³ to 1.50×10³ bubbles/cm³. In the opaque quartz glass II, the average cross-sectional area of microbubbles is 108 to 132 μm×108 to 132 μm and the bubble number density in the quartz glass substrate 10 is 1.50 bubbles/cm³ to 2.00 bubbles/cm³.

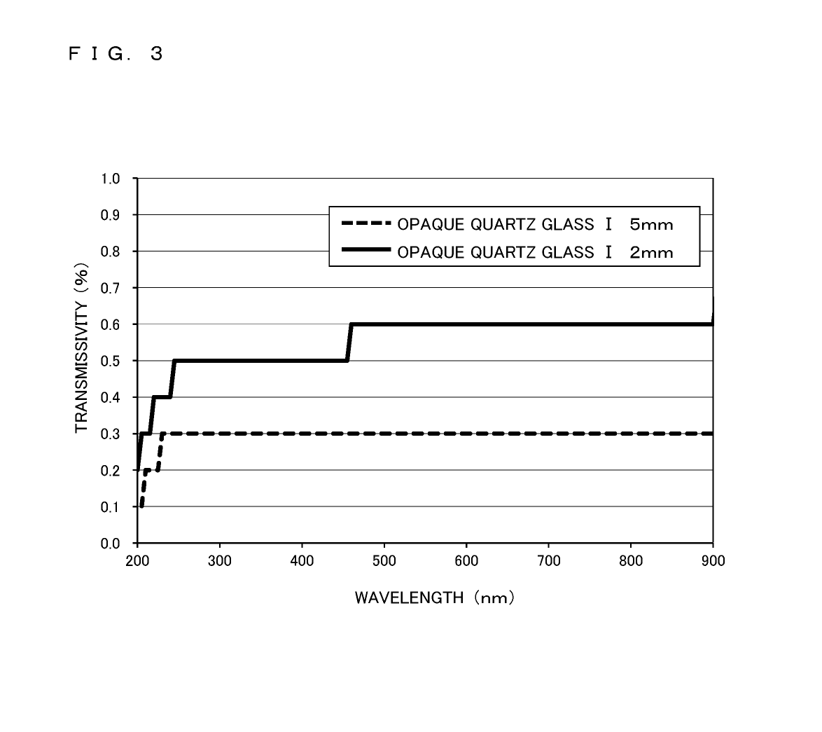

FIG. 3 is a graph illustrating the transmissivities of opaque quartz glass I. As illustrated in FIG. 3, measurement was performed on an opaque quartz glass I having a thickness of 2 mm and indicated by a solid line and an opaque quartz glass I having a thickness of 5 mm and indicated by a dashed line, by using a spectrophotometer (U-3010 fabricated by Hitachi). The vertical axis indicates the transmissivity in the unit of %. The horizontal axis indicates the wavelength in the unit of nm. The opaque quartz glass I having a thickness of 5 mm has a transmissivity of 0.3% in the range from 300 nm to 900 nm and the opaque quartz glass I having a thickness of 2 mm has a transmissivity of 0.5% to 0.6% in the range from 300 nm to 900 nm. As recognized from the results described above, in the opaque quartz glass, the transmissivity increases with decreasing plate thickness.

The porosity column indicates the abundance ratio (the fraction) of pores in the coating film 20. The employed unit is %. The measurement method for the abundance ratio of pores in the coating film 20 is described below. First, the coating film 20 is cut by using a dicing saw or the like, then the cut surface is polished, then an image of the cut surface of the coating film 20 is acquired by using a CCD (Charge-coupled device) camera, a digital camera, or the like, and then the acquired image is read into a computer. The computer performs image processing on the read-in image so as to measure the cross-sectional area of the pores. Then, the ratio obtained by dividing the measured cross-sectional area of the pores by the cross-sectional area of the entirety of the coating film 20 is expressed in percentage so that the abundance ratio of pores in the coating film 20 is obtained.

The average film thickness column indicates the average film thickness of the coating film 20. The employed unit is μm. The measurement method for the average film thickness of the coating film 20 is as follows. First, the thickness of the quartz glass substrate 10 having been etched and the thickness of the quartz glass substrate 10 on which the coating film 20 has been formed are measured by using a micrometer. Then, the difference between the thickness of the quartz glass substrate 10 having been etched and the thickness of the quartz glass substrate 10 on which the coating film 20 has been formed is calculated so that the average film thickness is measured. For example, the average film thickness of the coating film 20 is expressed as 20±5. Then, this indicates that the average film thickness is 20 μm and the error is 5 μm.

The surface roughness Ra column indicates the surface roughness Ra of the quartz glass substrate 10 having been etched. The employed unit is μm. In accordance with JISB0633, measurement employing a contact type surface roughness meter (Surfcom 130A fabricated by Tokyo Seimitsu) is performed at ten positions on one surface of the quartz glass substrate 10 having been etched and then the minimum value among them is adopted as the surface roughness Ra. In the measurement of the surface roughness Ra of the opaque quartz glass, in some cases, measurement is performed on a microbubble exposed to the surface in accordance with grinding so that the measured value at the microbubble position becomes greater than the measured value at a non-microbubble position. Thus, in the present embodiment, the minimum value has been employed for the purpose of eliminating the influence of microbubbles.

The processing condition column indicates the grinding method for the quartz glass substrate 10. For example, the grinding method for the quartz glass substrate 10 is grinding, rough grinding, sandblast, or the like. The grinding indicates a grinding method employing a metal-bonded diamond wheel having an abrasive grain size of #400 to #600. The rough grinding indicates a grinding method employing a metal-bonded diamond wheel having an abrasive grain size of #120 to #200. The sandblast indicates a surface roughening method of spraying SiC abrasive grains having an abrasive grain size #60 to #100 onto one surface in a state that the abrasive grains are mixed into compressed air.

The etching amount column indicates the depth of etching to be performed on the quartz glass substrate 10. The employed unit is μm. The measurement method for the etching depth is as follows. First, the thickness of the quartz glass substrate 10 having been ground and the thickness of the quartz glass substrate 10 having been etched are measured by using a micrometer. Then, the difference between the thickness of the quartz glass substrate 10 having been etched and the thickness of the quartz glass substrate 10 having been ground is calculated so that the etching depth is measured. For example, the etching amount is expressed as 10±2. Then, this indicates that the etching depth is 10 μm and the error is 2 μm.

The D50% grain diameter column indicates the D50% grain diameter in the silicon powder on a volume basis. The employed unit is μm. The D50% grain diameter in the silicon powder on a volume basis is defined as follows. On the basis of a cumulative distribution calculated with a laser-diffraction type particle size analyzer CILAS 1064 fabricated by Cilas, silicon powder is sequentially accumulated starting from the small grain diameter and then, when the accumulated silicon powder reaches 50%, the value of the grain diameter is adopted as the D50% grain diameter. Here, silicon powder having a D50% grain diameter of 25 μm or smaller aggregates together and hence handling thereof is difficult. Thus, such powder is not employed in the present embodiment. Here, in the present embodiment, the D50% grain diameter on a volume basis has been employed. Instead, the D50% grain diameter on a number basis or the like may be employed.

The column for the fraction of grains having a diameter of 100 μm or larger indicates the fraction of grains having a diameter of 100 μm or larger in the silicon powder. The employed unit is %. The fraction of grains having a diameter of 100 μm or larger in the silicon powder is defined as follows. On the basis of a cumulative distribution calculated with a laser-diffraction type particle size analyzer CILAS 1064, the accumulated value of grains having a diameter of 100 μm or larger is divided by the total accumulated value obtained by accumulation of all grain diameters. Then, the obtained ratio is expressed in percentage and then adopted as the fraction of grains having a diameter of 100 μm or larger.

The light shielding performance column indicates the transmissivity of the quartz glass part. The transmissivity of the quartz glass part was obtained such that measurement was performed on the quartz glass part according to each fabrication example by using a spectrophotometer (U-3010 fabricated by Hitachi). For example, the light shielding performance was evaluated by using ⊚, o, and x. ⊚ indicates that the transmissivity of the quartz glass part is 0%. o indicates that the transmissivity of the quartz glass part is 0.1% or lower. x indicates that the transmissivity of the quartz glass part is higher than 0.1%.

The heat resisting performance column indicates the heat resisting performance of the quartz glass part. The evaluation method for the heat resisting performance of the quartz glass part was as follows. The quartz glass part according to each fabrication example was heated to 1200 degree C. and then the heated quartz glass part was cooled to ordinary temperature (e.g., 23 degree C.). After that, in a state that the cooled quartz glass part was irradiated by using a 250-lumen high luminance white LED (Light Emitting Diode), the state of light transmission was visually observed so that the heat resisting performance of the quartz glass part was evaluated. For example, the heat resisting performance was evaluated by using ⊚, o, and x. ⊚ indicates that a crack was not found in the coating film 20. o indicates that a crack was found in the coating film 20. x indicates that a crack and a coating film spalling were found in the coating film 20.

The fabrication method for the quartz glass part fabricated according to fabrication example 1 is described below. One surface of the quartz glass substrate 10 formed from the opaque quartz glass I is ground by using a grinding machine provided with a metal-bonded diamond wheel having an abrasive grain size of #400 to #600. Then, etching of depth 10±2 μm is performed on the quartz glass substrate 10 having been ground, so that the surface roughness Ra of the quartz glass substrate 10 is made to be 2 to 4 μm. Further, silicon powder in which the D50% grain diameter is 25 to 35 μm and the abundance ratio of grains having a diameter of 100 μm or larger is 0% is thermal-sprayed onto the surface of the quartz glass substrate 10 having been etched, so that the coating film 20 is formed. In the coating film 20 formed on the surface of the quartz glass substrate 10, the average film thickness is 20±5 μm and the porosity is 1% to 4%. Further, in the quartz glass part fabricated in fabrication example 1 given above, the light shielding performance was evaluated as x and the heat resisting performance was evaluated as ⊚.

The quartz glass parts fabricated according to fabrication examples 2 to 8 were fabricated such that the average film thickness of each coating film was set to be 30±5 μm, 40±5 μm, 50±5 μm, 60±5 μm, 70±5 μm, 80±5 μm, or 90±5 μm and the other conditions were set to be the same as those in fabrication example 1.

The quartz glass part fabricated according to fabrication example 9 was fabricated such that the etching depth was set to be 1±1 μm and the other conditions were set to be the same as those in fabrication example 4.

The quartz glass part fabricated according to fabrication example 10 was fabricated such that the etching depth was set to be 5±1 μm and the other conditions were set to be the same as those in fabrication example 4.

The quartz glass part fabricated according to fabrication example 11 was fabricated such that the D50% grain diameter in the silicon powder was set to be 50 to 60 μm, the content percentage of grains of 100 μm or larger in the silicon powder was set to be 3%, and the other conditions were set to be the same as those in fabrication example 4.

The quartz glass part fabricated according to fabrication example 12 was fabricated such that the D50% grain diameter of the quartz glass part was set to be 70 to 80 μm, the content percentage of grains of 100 μm or larger in the silicon powder was set to be 10%, and the other conditions were set to be the same as those in fabrication example 4.

The fabrication method for the quartz glass part fabricated according to fabrication example 13 is described below. One surface of the quartz glass substrate 10 formed from the opaque quartz glass II is ground by using a grinding machine provided with a metal-bonded diamond wheel having an abrasive grain size of #400 to #600. Then, etching of depth 10±2 μm is performed on the quartz glass substrate 10 having been ground, so that the surface roughness Ra of the quartz glass substrate 10 is made to be 2 to 4 μm. Further, silicon powder in which the D50% grain diameter is 25 to 35 μm and the abundance ratio of grains having a diameter of 100 μm or larger is 0% is thermal-sprayed onto the surface of the quartz glass substrate 10 having been etched, so that the coating film 20 is formed. In the coating film 20 formed on the surface of the quartz glass substrate 10, the average film thickness is 20±5 μm and the porosity is 1% to 4%.

The quartz glass parts fabricated according to fabrication examples 14 to 20 were fabricated such that the average film thickness of each coating film was set to be 30±5 μm, 40±5 μm, 50±5 μm, 60±5 μm, 70±5 μm, 80±5 μm, or 90±5 μm and the other conditions were set to be the same as those in fabrication example 13.

The quartz glass parts fabricated according to fabrication examples 21 to 28 were fabricated such that surface roughening was performed by sandblast so as to realize a surface roughness Ra of 4 to 7 μm in the quartz glass substrate 10 and the other conditions were set to be the same as those in fabrication examples 1 to 8.

The quartz glass parts fabricated according to fabrication examples 29 to 36 were fabricated such that grinding was performed by rough grinding so as to realize a surface roughness Ra of 3 to 6 μm in the quartz glass substrate 10 and the other conditions were set to be the same as those in fabrication examples 1 to 8.

The quartz glass parts according to the present embodiment are examined with focusing attention on the abundance ratio of grains having a diameter of 100 μm or larger. In the quartz glass part fabricated according to fabrication example 12, the abundance ratio of grains having a diameter of 100 μm or larger is 10%, the light shielding performance is x, and the heat resisting performance is o. Further, in the quartz glass part fabricated according to fabrication example 11, the abundance ratio of grains having a diameter of 100 μm or larger is 3%, the light shielding performance is o, and the heat resisting performance is o. Further, in the quartz glass part fabricated according to fabrication example 4, the fraction of grains having a diameter of 100 μm or larger is 0%, the light shielding performance is ⊚, and the heat resisting performance is ⊚.

Thus, in the quartz glass part having a light shielding performance and a heat resisting performance, it is preferable that an opaque quartz glass substrate is employed and the abundance ratio of grains having a diameter of 100 μm or larger in the silicon powder is 3% or smaller. Further, it is more preferable that the abundance ratio of grains having a diameter of 100 μm or larger in the silicon powder is 0%. By virtue of this, in the quartz glass part, thickness reduction is allowed to be achieved and the light shielding property and the heat resisting property are allowed to be improved.

The quartz glass parts according to the present embodiment are examined with focusing attention on the D50% grain diameter. In the quartz glass part fabricated according to fabrication example 12, the D50% grain diameter is 70 to 80 μm, the light shielding performance is x, and the heat resisting performance is o. Further, in the quartz glass part fabricated according to fabrication example 11, the D50% grain diameter is 50 to 60 μm, the light shielding performance is o, and the heat resisting performance is o. Further, in the quartz glass part fabricated according to fabrication example 4, the D50% grain diameter is 25 to 35 μm, the light shielding performance is ⊚, and the heat resisting performance is ⊚.

Thus, in the quartz glass part having a light shielding performance and a heat resisting performance, it is preferable that the D50% grain diameter in the silicon powder is 50 to 60 μm. Further, it is more preferable that the D50% grain diameter in the silicon powder is 25 to 35 μm. By virtue of this, in the quartz glass part, the light shielding property and the heat resisting property are allowed to be improved further.

The quartz glass parts according to the present embodiment are examined with focusing attention on the average film thickness. In the quartz glass parts fabricated according to fabrication examples 3 to 5, the average film thickness is 40±5 to 60±5 μm, the light shielding performance is ⊚, and the heat resisting performance is ⊚. Further, in the quartz glass part fabricated according to fabrication example 15, the average film thickness is 40±5 μm, the light shielding performance is ⊚, and the heat resisting performance is ⊚. Further, in the quartz glass part fabricated according to fabrication example 3, the average film thickness is 30±5 μm, the light shielding performance is o, and the heat resisting performance is ⊚. Further, in the quartz glass part fabricated according to fabrication example 6, the average film thickness is 70±5 μm, the light shielding performance is ⊚, and the heat resisting performance is o.

Thus, in the quartz glass part having a light shielding performance and a heat resisting performance, it is preferable that the average film thickness of the coating film 20 is 40±5 to 60±5 μm. Further, it is more preferable that the average film thickness of the coating film 20 is 40±5 μm. By virtue of this, in the quartz glass part, the light shielding property and the heat resisting property are allowed to be improved further.

The quartz glass parts according to the present embodiment are examined with focusing attention on the surface roughness Ra. In the quartz glass part fabricated according to fabrication example 4, the surface roughness Ra is 2 to 4 μm, the light shielding performance is ⊚, and the heat resisting performance is ⊚. Further, in the quartz glass part fabricated according to fabrication example 24, the surface roughness Ra is 4 to 7 μm, the light shielding performance is ⊚, and the heat resisting performance is o. Further, in the quartz glass part fabricated according to fabrication example 32, the surface roughness Ra is 3 to 6 μm, the light shielding performance is ⊚, and the heat resisting performance is o.

Thus, in the quartz glass part having a light shielding performance and a heat resisting performance, when an opaque quartz glass substrate is employed, it is preferable that the surface roughness Ra of the quartz glass substrate 10 is 2 to 7 μm. Further, it is more preferable that the surface roughness Ra of the quartz glass substrate 10 is 2 to 4 μm. By virtue of this, in the quartz glass part, the light shielding property and the heat resisting property are allowed to be improved further.

The quartz glass parts according to the present embodiment are examined with focusing attention on the processing condition. In the quartz glass part fabricated according to fabrication example 4, the processing condition is grinding, the light shielding performance is ⊚, and the heat resisting performance is ⊚. Further, in the quartz glass part fabricated according to fabrication example 24, sandblast is employed, the light shielding performance is ⊚, and the heat resisting performance is o. Further, in the quartz glass part fabricated according to fabrication example 32, rough grinding is employed, the light shielding performance is ⊚, and the heat resisting performance is o.

Thus, in the quartz glass part having a light shielding performance and a heat resisting performance, when an opaque quartz glass substrate is employed, it is preferable that the processing condition is sandblast or rough grinding. Further, it is more preferable that the processing condition is grinding. By virtue of this, in the quartz glass part, the light shielding property and the heat resisting property are allowed to be improved further.

In the quartz glass part having a light shielding performance and a heat resisting performance, it is preferable that the abundance ratio of pores contained in the coating film 20 is 1% to 4%. By virtue of this, even when the coating film 20 is made thin, the light shielding property is allowed to be ensured. Here, in the quartz glass part according to the present embodiment, even when the abundance ratio of pores contained in the coating film 20 is 0%, the light shielding property is allowed to be ensured.

### Embodiment 2

Quartz glass parts were fabricated under the conditions illustrated in Embodiment 1 and in a state that the base material of the quartz glass substrate 10 was changed to a transparent quartz glass having light transmissivity.

The fabrication examples of the quartz glass parts according to Embodiment 2 are listed in the following Table 3.

TABLE 3

| | | COATING FILM | | QUARTZ GLASS SUBSTRATE | | |
|---|---|---|---|---|---|---|
| | | | AVERAGE | SURFACE | | |
| FABRICATION | | | FILM | ROUGHNESS | PROCESSING | ETCHING |
| EXAMPLE | TYPE | POROSITY | THICKNESS | Ra | CONDITION | AMOUNT |
| FABRICATION | TRANSPARENT | 1~4 | 20 ± 5 | 1~3 | GRINDING | 10 ± 2 |
| EXAMPLE 37 | QUARTZ GLASS I | | | | | |
| FABRICATION | TRANSPARENT | 1~4 | 30 ± 5 | 1~3 | GRINDING | 10 ± 2 |
| EXAMPLE 38 | QUARTZ GLASS I | | | | | |
| FABRICATION | TRANSPARENT | 1~4 | 40 ± 5 | 1~3 | GRINDING | 10 ± 2 |
| EXAMPLE 39 | QUARTZ GLASS I | | | | | |
| FABRICATION | TRANSPARENT | 1~4 | 50 ± 5 | 1~3 | GRINDING | 10 ± 2 |
| EXAMPLE 40 | QUARTZ GLASS I | | | | | |
| FABRICATION | TRANSPARENT | 1~4 | 60 ± 5 | 1~3 | GRINDING | 10 ± 2 |
| EXAMPLE 41 | QUARTZ GLASS I | | | | | |
| FABRICATION | TRANSPARENT | 1~4 | 70 ± 5 | 1~3 | GRINDING | 10 ± 2 |
| EXAMPLE 42 | QUARTZ GLASS I | | | | | |
| FABRICATION | TRANSPARENT | 1~4 | 80 ± 5 | 1~3 | GRINDING | 10 ± 2 |
| EXAMPLE 43 | QUARTZ GLASS I | | | | | |
| FABRICATION | TRANSPARENT | 1~4 | 90 ± 5 | 1~3 | GRINDING | 10 ± 2 |
| EXAMPLE 44 | QUARTZ GLASS I | | | | | |
| FABRICATION | TRANSPARENT | 1~4 | 30 ± 5 | 1~3 | GRINDING | 10 ± 2 |
| EXAMPLE 45 | QUARTZ GLASS | | | | | |
| | II | | | | | |
| FABRICATION | TRANSPARENT | 1~4 | 40 ± 5 | 1~3 | GRINDING | 10 ± 2 |
| EXAMPLE 46 | QUARTZ GLASS | | | | | |
| | II | | | | | |
| FABRICATION | TRANSPARENT | 1~4 | 50 ± 5 | 1~3 | GRINDING | 10 ± 2 |
| EXAMPLE 47 | QUARTZ GLASS | | | | | |
| | II | | | | | |
| FABRICATION | TRANSPARENT | 1~4 | 60 ± 5 | 1~3 | GRINDING | 10 ± 2 |
| EXAMPLE 48 | QUARTZ GLASS | | | | | |
| | II | | | | | |
| FABRICATION | TRANSPARENT | 1~4 | 70 ± 5 | 1~3 | GRINDING | 10 ± 2 |
| EXAMPLE 49 | QUARTZ GLASS | | | | | |
| | II | | | | | |

| | SILICON POWDER | | | |
|---|---|---|---|---|
| | | A FRACTION | EVALUATION OF | |
| | | OF GRAIN | PERFORMANCE | |
| | D50% | DIAMETER | LIGHT | HEAT |
| FABRICATION | GRAIN | OF 100 μm | SHIELDING | RESISTING |
| EXAMPLE | DIAMETER | OR LARGER | PERFORMANCE | PERFORMANCE |
| FABRICATION | 25~35 | 0 | X | ⊚ |
| EXAMPLE 37 | | | | |
| FABRICATION | 25~35 | 0 | X | ⊚ |
| EXAMPLE 38 | | | | |
| FABRICATION | 25~35 | 0 | X | ⊚ |
| EXAMPLE 39 | | | | |
| FABRICATION | 25~35 | 0 | ◯ | ◯ |
| EXAMPLE 40 | | | | |
| FABRICATION | 25~35 | 0 | ⊚ | ◯ |
| EXAMPLE 41 | | | | |
| FABRICATION | 25~35 | 0 | ⊚ | X |
| EXAMPLE 42 | | | | |
| FABRICATION | 25~35 | 0 | ⊚ | X |
| EXAMPLE 43 | | | | |
| FABRICATION | 25~35 | 0 | ⊚ | X |
| EXAMPLE 44 | | | | |
| FABRICATION | 25~35 | 0 | X | ⊚ |
| EXAMPLE 45 | | | | |
| FABRICATION | 25~35 | 0 | ◯ | ⊚ |
| EXAMPLE 46 | | | | |
| FABRICATION | 25~35 | 0 | ⊚ | ◯ |
| EXAMPLE 47 | | | | |
| FABRICATION | 25~35 | 0 | ⊚ | ◯ |
| EXAMPLE 48 | | | | |
| FABRICATION | 25~35 | 0 | ⊚ | X |
| EXAMPLE 49 | | | | |

For example, the quartz glass substrate column describes transparent quartz glass I or transparent quartz glass II. The transparent quartz glass I is a quartz glass substrate whose surface (the non-thermal-sprayed surface) on the side without thermal spraying is polishing-finished by using a lapping machine or, alternatively, burning-finished by flame treatment into a smooth surface. Then, the surface roughnesses Ra of the two surfaces of the transparent quartz glass I are approximately 0.01 μm. The transparent quartz glass II is a quartz glass substrate whose one surface is polished into a smooth surface and whose the other surface (the non-thermal-sprayed surface) is ground (roughened) into an quartz glass state such frosted glass by sandblast. The surface roughness Ra of the other surface of the transparent quartz glass II is 4.77 μm.

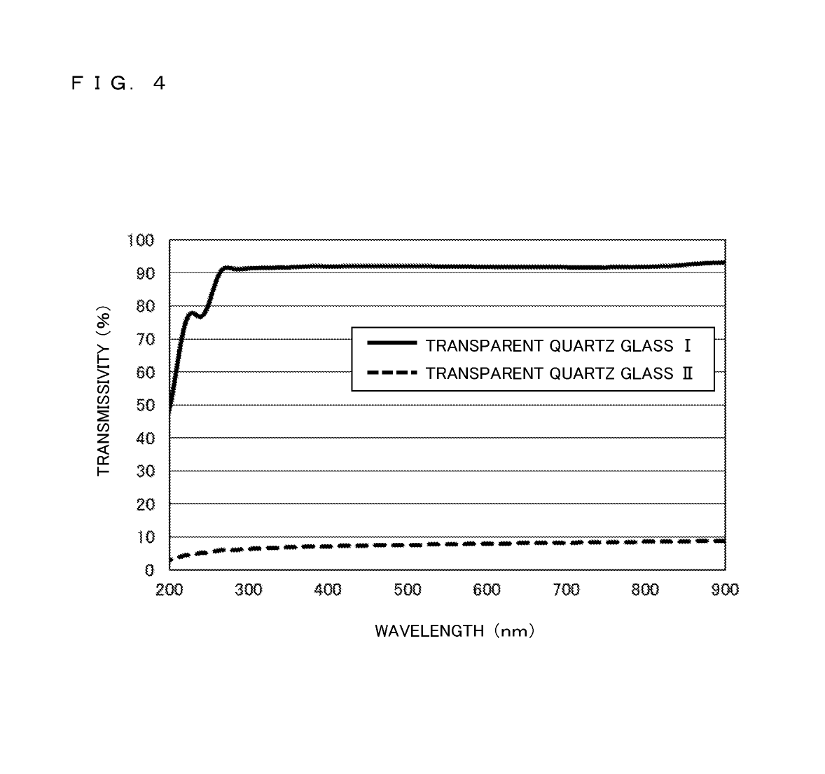

FIG. 4 is a graph illustrating the transmissivities of the transparent quartz glass I and the transparent quartz glass II. As illustrated in FIG. 4, measurement was performed on the transparent quartz glass I having a thickness of 5 mm and indicated by a solid line and the transparent quartz glass II having a thickness of 5 mm and indicated by a dashed line, by using a spectrophotometer (U-3010 fabricated by Hitachi). The vertical axis indicates the transmissivity in the unit of %. The horizontal axis indicates the wavelength in the unit of nm. The transparent quartz glass I has a transmissivity of 90% to 95% in the range from 300 nm to 900 nm. The transparent quartz glass II has a transmissivity of 5% to 10% in the range from 300 nm to 900 nm.

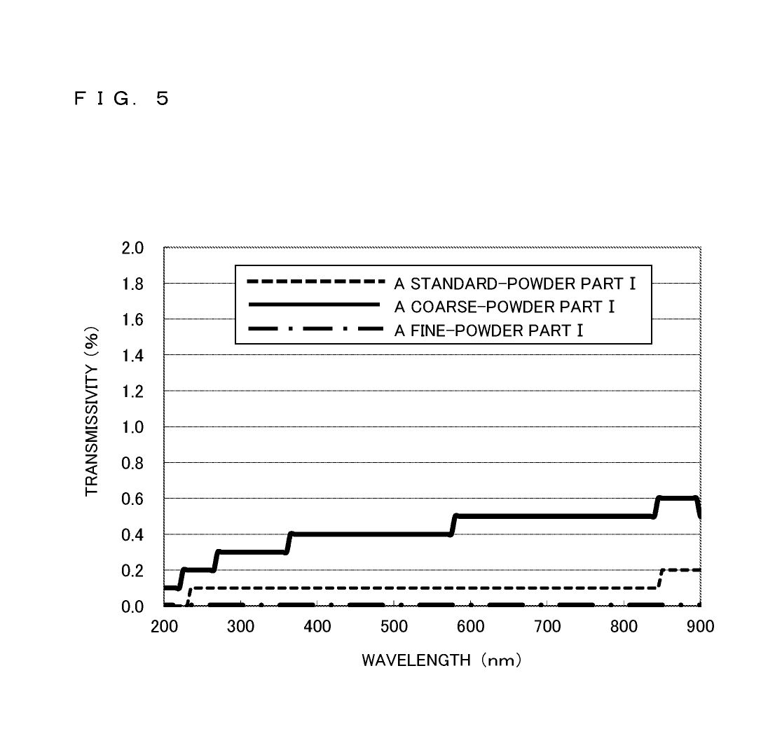

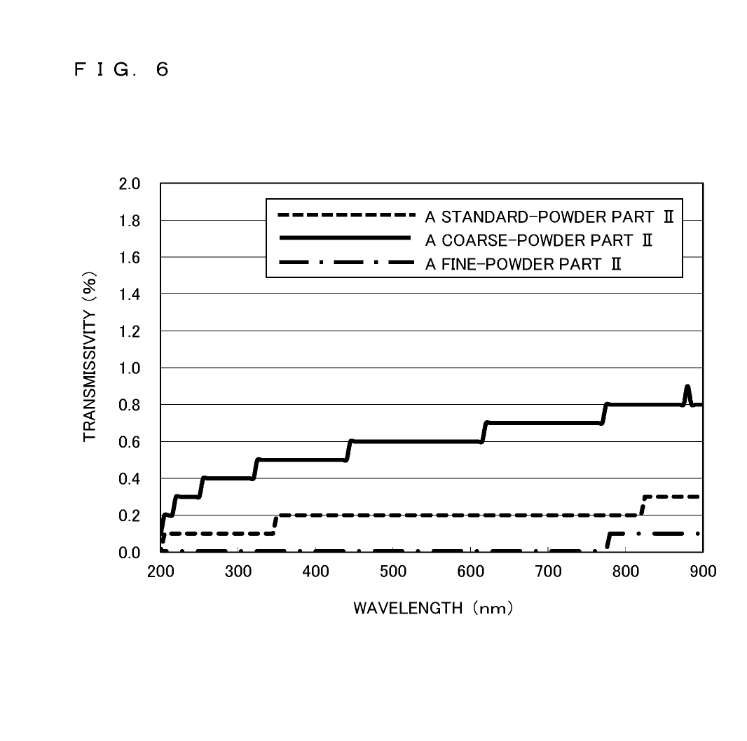

FIG. 5 is a graph illustrating the transmissivities of the quartz glass parts prior to heating. FIG. 6 is a graph illustrating the transmissivities of the quartz glass parts posterior to heating. The fabrication method for the individual quartz glass parts illustrated in FIG. 5 is described below. One surface of the quartz glass substrate 10 formed from the transparent quartz glass I and having a thickness of 5 mm is ground by using a grinding machine provided with a metal-bonded diamond wheel having an abrasive grain size of #400 to #600. Then, etching is performed on the quartz glass substrate 10 having been ground, under the same conditions as Embodiment 1 so that the surface roughness Ra of the quartz glass substrate 10 is made into 3 to 4.5 μm. Further, silicon powder having a D50% grain diameter of 21, 28, or 32 μm is thermal-sprayed onto the surface of the quartz glass substrate 10 having been etched, so that the coating film 20 is formed. In the coating film 20 formed on the surface of the quartz glass substrate 10, the average film thickness is 20 to 30 μm and the porosity is 1% to 4%.

As illustrated in FIG. 5, measurement was performed on a standard-powder part I indicated by a dashed line, a coarse-powder part I indicated by a solid line, and a fine-powder part I indicated by a dash-dotted line, by using a spectrophotometer (U-3010 fabricated by Hitachi). Here, the standard-powder part I indicates a quartz glass part fabricated from silicon powder whose D50% grain diameter is 28 μm. The coarse-powder part I indicates a quartz glass part fabricated from silicon powder whose D50% grain diameter is 32 μm. The fine-powder part I indicates a quartz glass part fabricated from silicon powder whose D50% grain diameter is 21 μm.

As illustrated in FIG. 6, measurement was performed on a standard-powder part II indicated by a dashed line, a coarse-powder part II indicated by a solid line, and a fine-powder part II indicated by a dash-dotted line, by using a spectrophotometer (U-3010 fabricated by Hitachi). The standard-powder part II, the coarse-powder part II, and the fine-powder part II are quartz glass parts obtained by heat treatment of the standard-powder part I, the coarse-powder part I, and the fine-powder part I, respectively, at 1200 degree C.

The vertical axes in FIGS. 5 and 6 indicate the transmissivity in the unit of %. The horizontal axes in FIGS. 5 and 6 indicate the wavelength in the unit of nm.

As illustrated in FIG. 5, as for the transmissivity in the range from 200 nm to 900 nm, the standard-powder part I has values from 0.1% to 0.2%, the coarse-powder part I has values from 0% to 0.6%, and the fine-powder part I has a value of 0%.

As illustrated in FIG. 6, as for the transmissivity in the range from 200 nm to 900 nm, the standard-powder part II has values from 0.1% to 0.2%, the coarse-powder part II has values from 0.2% to 0.8%, and the fine-powder part II has a value of 0% to 0.1%.

The fabrication method for the quartz glass part fabricated according to fabrication example 37 is described below. One surface of the quartz glass substrate 10 formed from the transparent quartz I is ground by using a grinding machine provided with a metal-bonded diamond wheel having an abrasive grain size of #400 to #600. Then, etching of depth 10±2 μm is performed on the quartz glass substrate 10 having been ground, so that the surface roughness Ra of the quartz glass substrate 10 is made to be 1 to 3 μm. Further, silicon powder in which the D50% grain diameter is 25 to 35 μm and the abundance ratio of grains having a diameter of 100 μm or larger is 0% is thermal-sprayed onto the surface of the quartz glass substrate 10 having been etched, so that the coating film 20 is formed. In the coating film 20 formed on the surface of the quartz glass substrate 10, the average film thickness is 20±5 μm and the porosity is 1% to 4%.

The quartz glass parts fabricated according to fabrication examples 38 to 44 were fabricated such that the average film thickness of each coating film was set to be 30±5 μm, 40±5 μm, 50±5 μm, 60±5 μm, 70±5 μm, 80±5 μm, or 90±5 μm and the other conditions were set to be the same as those in fabrication example 37.

The fabrication method for the quartz glass part fabricated according to fabrication example 45 is described below. One surface of the quartz glass substrate 10 formed from the transparent quartz glass II is ground by using a grinding machine provided with a metal-bonded diamond wheel having an abrasive grain size of #400 to #600. Then, etching of depth 10±2 μm is performed on the quartz glass substrate 10 having been ground, so that the surface roughness Ra of the quartz glass substrate 10 is made to be 1 to 3 μm. Further, silicon powder in which the D50% grain diameter is 25 to 35 μm and the abundance ratio of grains having a diameter of 100 μm or larger is 0% is thermal-sprayed onto the surface of the quartz glass substrate 10 having been etched, so that the coating film 20 is formed. In the coating film 20 formed on the surface of the quartz glass substrate 10, the average film thickness is 30±5 μm and the porosity is 1% to 4%.

The quartz glass parts fabricated according to fabrication examples 46 to 49 were fabricated such that the average film thickness of each coating film was set to be 40±5 μm, 50±5 μm, 60±5 μm, or 70±5 μm and the other conditions were set to be the same as those in fabrication example 45.

The quartz glass parts according to the present embodiment are examined with focusing attention on the light shielding performance and the heat resisting performance. Quartz glass parts whose light shielding performance or heat resisting performance is ⊚ and whose light shielding performance and heat resisting performance are not x are the quartz glass parts fabricated in fabrication examples 41 and 46 to 48. Thus, it is preferable that the quartz glass part having a light shielding property and a heat resisting property is fabricated according to fabrication examples 41, 46 to 48.

The quartz glass parts according to the present embodiment are examined with focusing attention on the average film thickness. In the quartz glass part fabricated according to fabrication example 41 or 48, the average film thickness is 60±5 μm, the light shielding performance is ⊚, and the heat resisting performance is o. Further, in the quartz glass part fabricated according to fabrication example 46, the average film thickness is 40±5 μm, the light shielding performance is o, and the heat resisting performance is ⊚. Further, in the quartz glass part fabricated according to fabrication example 47, the average film thickness is 50±5 μm, the light shielding performance is ⊚, and the heat resisting performance is o.

Thus, in the quartz glass part having a light shielding performance and a heat resisting performance, it is preferable that the quartz glass substrate 10 having light transmissivity is employed, the fraction of grains having a diameter of 100 μm or larger in the silicon powder is 0%, the D50% grain diameter in the silicon powder on a number basis is 25 to 35 μm, and the average film thickness of the coating film 20 is 40±5 to 60±5 μm. Further, it is more preferable that the average film thickness of the coating film 20 is 60±5 μm. By virtue of this, in the quartz glass part, the light shielding property and the heat resisting property are allowed to be improved.

Further, in the quartz glass part according to the present embodiment, when the transparent quartz glass II is employed, even when the average film thickness is 40±5 to 50±5 μm, a quartz glass part whose light shielding performance or heat resisting performance is ⊚ and whose light shielding performance and heat resisting performance are not x is allowed to be fabricated. Thus, in the quartz glass part according to the present embodiment, since the other surface of the quartz glass substrate 10 is roughened, the roughened surface scatters light so that the light shielding property of the quartz glass part is allowed to be improved further.

### Embodiment 3

Embodiment 3 of the present invention is described below in detail with reference to the drawings illustrating this embodiment. In the flowing description, the configuration and the operation other than those described otherwise are similar to those of Embodiment 1 or 2. Then, for simplicity, these are denoted by like numerals and their description is not given.

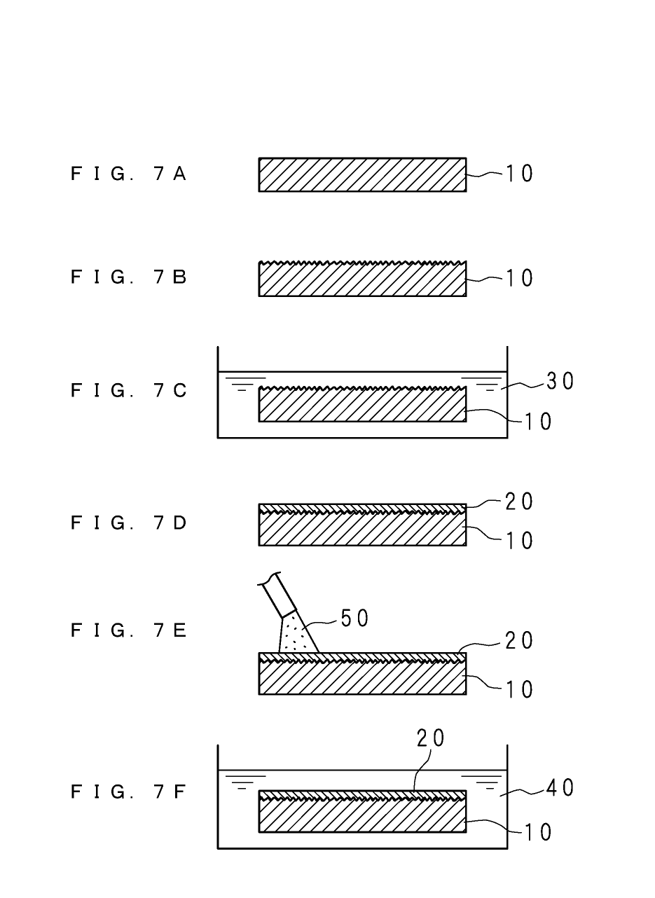

FIGS. 7A to 7F are schematic diagrams schematically illustrating a fabrication method for a quartz glass part according to Embodiment 3. The processes in FIGS. 7A to 7D are substantially similar to those of Embodiment 1 and hence their description is not given here. In the fabrication method for a quartz glass part according to Embodiment 3, dry ice 50 is sprayed onto the coating film 20 formed on the quartz glass substrate 10 so that cleaning is achieved. The dry ice 50 is composed of particles having an average grain diameter of a few 10 to a few 100 μm and is sprayed through a nozzle onto the coating film 20 together with compressed air discharged from a compressor (not illustrated). The sprayed dry ice 50 collides with the surface of the coating film 20 at high speed so as to remove adhering impurities or unstable particles serving as a particle factor, by means of heat contraction caused by a decrease in the surface temperature and volume expansion caused by sublimation. FIG. 7E illustrates a sectional view of the quartz glass part in the process of spraying the dry ice 50.

Etching is performed on the coating film 20 onto which the dry ice 50 has been sprayed. For example, the quartz glass part is immersed in an HF solution 40 having a concentration of 1% and a solution temperature of 20, for 1 minute so that the oxide film is etched by a few 10 to a few 100 nm. FIG. 4F illustrates a sectional view of the quartz glass part in the etching process.

Evaluation of the amount of particles on the surface was performed on the quartz glass part having been etched, the quartz glass part onto which the dry ice 50 has been sprayed, and the quartz glass part onto which the dry ice 50 has been sprayed and then etching has been performed. The evaluation method for the amount of particles was such that the total particle count from 0.3 to 5 μm was measured on the quartz glass part by using a particle counter (QIIIMax fabricated by PENTAGON TECHNOLOGIES). The unit of the total particle count was particles/cm². When the total particle count was 30 particles/cm² or more, a large amount of particles was concluded. Further, when the total particle count was 30 particles/cm² or fewer, a small amount of particles was concluded.

As a result, the quartz glass part having been etched and the quartz glass part onto which the dry ice 50 has been sprayed were evaluated as having a large amount of particles. Further, the quartz glass part onto which the dry ice 50 has been sprayed and then etching was performed was evaluated as having a small amount of particles.

In the quartz glass part according to the present Embodiment 3, performed are: the spraying process of spraying the dry ice particles 50 onto the coating film 20 formed on the quartz glass substrate 10; and the etching process of etching the coating film 20 with the HF solution 30. Thus, adhering substances serving as a source of particles on the thermal-sprayed film surface are allowed to be effectively removed.

### Embodiment 4

Embodiment 4 of the present invention is described below in detail with reference to the drawings illustrating this embodiment. In the flowing description, the configuration and the operation other than those described otherwise are similar to those of Embodiments 1 to 3. Then, for simplicity, these are denoted by like numerals and their description is not given.

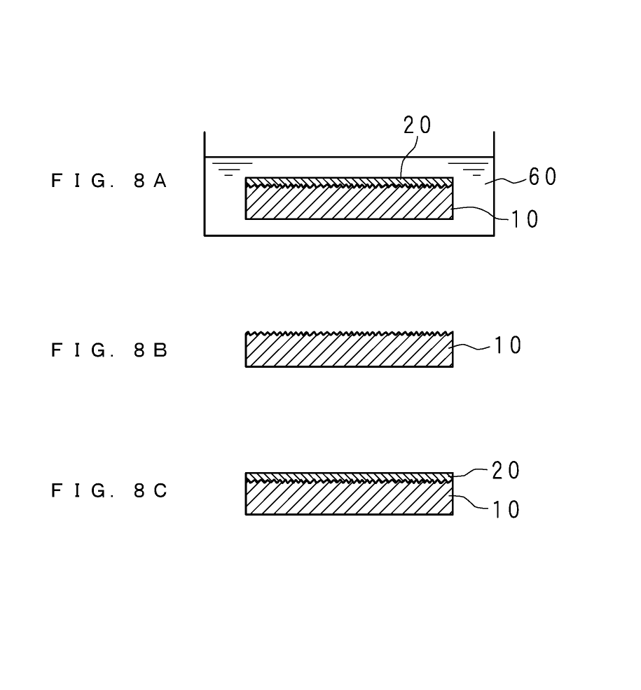

FIGS. 8A to 8C are schematic diagrams schematically illustrating a re-formation method for the coating film 20 of the quartz glass part. The re-formation method for the coating film 20 of the quartz glass part is described below. The quartz glass substrate 10 on which the coating film 20 has been formed is immersed in an alkali solution 60 so that etching is continued until the coating film 20 is spalled. For example, the alkali solution 60 is a TMAH solution or a KOH solution. FIG. 8A illustrates a sectional view of the quartz glass substrate 10 on which the coating film 20 has been formed, in the etching process. FIG. 8B illustrates a sectional view of the quartz glass substrate 10 in which the coating film 20 has been spalled by etching. As such, when an alkali solution that dissolves the coating film 20 and does not dissolve the quartz glass substrate is employed, the coating film 20 is allowed to be dissolved and spalled and then the quartz glass substrate is allowed to be recycled. Further, the surface shape of the thermal-sprayed surface of the quartz glass substrate 10 is not changed. Thus, after the spalling of the coating film 20, thermal spraying is allowed to be performed again without requirement of surface processing on the quartz glass substrate 10.

Silicon powder is thermal-sprayed from the plasma spraying apparatus onto the quartz glass substrate 10 from which the coating film 20 has been spalled, so that the coating film 20 is formed in a portion where light shielding or heat shielding is required. FIG. 8C illustrates a sectional view of the quartz glass substrate 10 on which the coating film 20 has been formed.

In the quartz glass part according to the present Embodiment 4, performed are: the etching process of etching the coating film 20 formed on the quartz glass substrate 10; and the re-thermal-spraying process of thermal-spraying silicon powder onto the quartz glass substrate 10 from which the coating film 20 has been spalled. By virtue of this, the quartz glass part is allowed to be recycled.

The embodiments disclosed above are illustrative at all points and to be recognized as non-restrictive. The scope of the present invention is specified by the claim and not by the description given above, and is intended to include all changes within the scope and spirit equivalent to those of the claim.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1-14. (canceled)

15. A quartz glass part constructed such that silicon powder is plasma-sprayed onto a surface of a quartz glass substrate and thereby a coating film is formed, wherein
the quartz glass substrate is composed of opaque quartz glass and a fraction of grains having a diameter of 100 μm or larger in the silicon powder is 3% or smaller.

16. The quartz glass part according to claim 15, wherein
the fraction of grains having a diameter of 100 μm or larger in the silicon powder is 0% and
a D50% grain diameter in the silicon powder is 25 to 35 μm.

17. The quartz glass part according to claim 15, wherein an average film thickness of the coating film is 40 to 60 μm.

18. The quartz glass part according to claim 15, wherein a surface roughness Ra of the quartz glass substrate is 2 to 4 μm.

19. The quartz glass part according to claim 15, wherein a porosity of the coating film is 1% to 4%.

20. A fabrication method for a quartz glass part, comprising:
preparing on an opaque quartz glass substrate; and
forming a coating film by thermal-spraying silicon powder, in which a fraction of grains having a diameter of 100 μm or larger is 3% or smaller, onto a surface of the quartz glass substrate.

21. The fabrication method for a quartz glass part according to claim 20, wherein the coating film is formed by employing silicon powder in which the fraction of grains having a diameter of 100 μm or larger is 0% and a D50% grain diameter is 25 to 35 μm.

22. The fabrication method for a quartz glass part according to claim 20, comprising:
spraying dry ice particles onto the coating film formed on the quartz glass substrate; and
etching the coating film onto which the particles have been sprayed, with a hydrofluoric-acid-based chemical liquid.

23. A quartz glass part constructed such that silicon powder is thermal-sprayed onto a quartz glass substrate and thereby a coating film is formed on the surface, wherein:
the quartz glass substrate is composed of transparent quartz glass;
a fraction of grains having a diameter of 100 μm or larger in the silicon powder is 0%;
a D50% grain diameter in the silicon powder is 25 to 35 μm;
an average film thickness of the coating film is 40 to 60 μm; and
a surface roughness Ra of the quartz glass substrate is 1 to 3 μm.

24. The quartz glass part according to claim 23, wherein a non-thermal-sprayed surface in the quartz glass substrate is roughened into a quartz glass state such frosted glass.

25. The quartz glass part according to claim 23, wherein a porosity of the coating film is 1% to 4%.

26. A fabrication method for a quartz glass part, comprising:
preparing a coating film formed on a transparent quartz glass substrate with a surface roughness Ra of 1 to 3 μm; and
forming a coating film with an average film thickness of 40 to 60 μm by thermal-spraying silicon powder, in which a fraction of grains having a diameter of 100 μm or larger is 0% and a D50% grain diameter is 25 to 35 onto a surface of the quartz glass substrate.

27. The fabrication method for a quartz glass part according to claim 26, wherein, prior to formation of the coating film, a non-thermal-sprayed surface in the quartz glass substrate is roughened into a quartz glass state such frosted glass.

28. The fabrication method for a quartz glass part according to claim 26, comprising:
spraying dry ice particles onto the coating film formed on the quartz glass substrate; and
etching the coating film onto which the particles have been sprayed, with a hydrofluoric-acid-based chemical liquid.
